(19) United States
(12) Patent Application Publication
(10) Pub. No.: US 2026/0118286 A1
(43) Pub. Date: Apr. 30, 2026

(54) DEFICIENCY TESTING DEVICE FOR DEFICIENCY TESTING OF X-RAY PROTECTIVE GARMENTS

(71) Applicant: IMS BV, Dokkum (NL)

(72) Inventors: Jan Jelle VAN DER VEEN, Dokkum (NL); Constantijn Adriaan EEKHOUT, Dokkum (NL); Trienko Marten Van Der Kaap, DOKKUM (NL); Rutger Loerts, Dokkum (NL); Erwin Hoberg, Dokkum (NL); Jacob Hendrik Sjaak Eijenhuijsen, Dokkum (NL)

(21) Appl. No.: 19/470,539

(22) PCT Filed: Mar. 28, 2024
(86) PCT No.: PCT/EP2024/058728

§ 371 Date: Sep. 29, 2025

(30) Foreign Application Priority Data
Mar. 29, 2023 (NL) 2034464

(51) Int. Cl. G01N 23/04; G01N 23/083; G01N 23/18

(52) U.S. Cl. CPC G01N 23/04; G01N 23/083; G01N 23/18

(57) ABSTRACT

Disclosed is a deficiency testing device for deficiency testing x-ray protective garments, comprising a mannequin configured to support a protective garment to be tested; at least one X-ray source; and at least one X-ray detector; wherein one of the at least one X-ray source and the at least one X-ray detector is positioned within the mannequin and wherein the other of the at least one X-ray source and the at least one X-ray detector is positioned outside the mannequin. The invention further relates to a system for deficiency testing of X-ray protective garments and a method for deficiency testing of X-ray protective garments.

### REFERENCE TO RELATED APPLICATIONS

This application is a national stage application under 35 U.S.C. § 371 which claims the benefit of the filing date of PCT/EP2024/058728 titled “Deficiency Testing for Deficiency Testing of X-Ray Protective Garments” and filed 28 Mar. 2024, which claims the benefit of Netherlands U.S. Pat. No. 2,034,464, titled “ Deficiency Testing for Deficiency Testing of X-Ray Protective Garments”, filed 29 Mar. 2023, the subject matter of each of which is incorporated herein by reference.

### CROSS REFERENCES

### Not Applicable

### STATEMENT REGARDING FEDERALLY SPONSORED RESEARCH OR DEVELOPMENT

Not applicable

### INCORPORATION BY REFERENCE OF MATERIAL SUBMITTED ON A COMPACT DISK

Not applicable

### TECHNICAL FIELD

The invention relates to a deficiency testing device for deficiency testing of X-ray protective garments. The invention further relates to a system and a method for deficiency testing of X-ray protective garments.

### BACKGROUND OF THE DISCLOSURE

X-ray protective garments are known from practice and are widely used in hospitals, care-centres and other locations in which X-ray imaging is applied. Most X-ray protective garments, such as aprons, have a protective layer which needs to be tested on a regular basis in order to establish whether no deficiencies are present. Such layers may be lead or a lead replacement material with similar protective properties. Deficiencies in such layers may result in operators and/or patients being unnecessarily subjected to X-ray radiation leading to avoidable health hazards. This is especially true in locations in which medical care is provided, such as hospitals, retirement homes with a (medical) care department etc.

Known testing device include a table or conveyor on which the protective clothing is positioned. Subsequently, the protective clothing is positioned in or moved through a scanner in which the clothing is irradiated with X-rays. The screening is used to determine the presence and, if present, the location of deficiencies.

### BRIEF SUMMARY OF THE DISCLOSURE

A disadvantage of the known scanners is that the scanner is insufficiently capable of determining the location of deficiencies. As a result, protective clothing is incorrectly rejected as deficient, or, alternatively, incorrectly approved.

The present invention is aimed at obviating or at least reducing the aforementioned problems by providing a deficiency testing device having an increased capability of determining deficiencies, in particular the location thereof. To that end, the invention provides a deficiency testing device for deficiency testing protective garments, preferably x-ray protective garments, the device comprising:
a mannequin configured to support a protective garment to be tested;
at least one X-ray source; and
at least one X-ray detector;
wherein one of the at least one X-ray source and the at least one X-ray detector is positioned within the mannequin and wherein the other of the at least one X-ray source and the at least one X-ray detector is positioned outside the mannequin.

### BRIEF DESCRIPTION OF THE DRAWINGS

Further advantages, features and details of the invention are elucidated on the basis of preferred embodiments thereof, wherein reference is made to the accompanying drawings, in which:

FIG. 1 shows a perspective view of an example of a deficiency testing device according to the invention;

FIG. 2 shows a detailed view of an upper section of the example of FIG. 1;

FIG. 3 shows a side view of the example of FIG. 1;

FIG. 4 shows a front view of the example of FIG. 1;

FIG. 5 shows a detailed view of an upper section of central support of the example of FIG. 1;

FIG. 6 shows a detailed view of a middle section of central support of the example of FIG. 1;

FIG. 7 shows a schematic example of a method according to the invention;

FIGS. 8a, 8b show an example of a scan image of an X-ray protective garment made using a deficiency testing device according to the invention; and

FIG. 8c shows an example of a scan image of an bullet-proof garment made using a deficiency testing device according to the invention.

### DETAILED DESCRIPTION

In the deficiency testing device according to the invention, the at least one X-ray source or the at least one X-ray detector is positioned within the mannequin and the other is positioned outside the mannequin, thus providing at least a part of the mannequin between the at least one X-ray source and the at least one X-ray detector. As a result, the garment is positioned on the mannequin similar to the position in which it is positioned on a person when used. This means that only a single side of the garment is positioned between the source and the detector at a given time. This may for example be the rear layer (often comprising a single layer of fabric) or a front layer (often comprising a double layer of fabric).

An advantage is that the fabric of the garment to be tested is screened as positioned during normal use by a person, thus providing an increased capability of detecting deficiencies in X-ray protective clothing.

Another advantage of the deficiency testing device according to the invention is that the power output of the X-ray source can be significantly reduced compared to the known devices while maintaining or even improving the deficiency scan results.

A further advantage of the deficiency testing device according to the invention is that, due to the lower power output that is required, the amount of shielding provided on the device can be reduced. This reduces the cost of the device. It also decreases the risks associated with the use of X-ray devices, since the strength of the X-ray radiation used is lower than in the known devices.

Yet another advantage is that, due to the use of a dedicated deficiency testing device, the use of devices meant for scanning patients no longer need to be used for deficiency testing. This increases the uptime of the X-ray devices primarily designed for scanning patients.

A further advantage is that the device according to the invention can also be used to scan protective garment in the form of neck protection pieces. In fact, multiple neckpieces may be scanned using the devices in a single testing or screening operation.

Yet a further advantage is that the device according to the invention can be used to distinguish between a front and a back of the garment to be tested. This is possible due to the relative positioning of the X-ray detector and the X-ray source to each other. It is noted that the term ‘within’ used in the application also includes known similar wording, include for example ‘in’ or ‘inside’. These terms are used interchangeably in this application and are considered to have the same or similar meaning.

Similarly, the terms ‘X-ray protective clothing’, ‘X-ray protective garment’, ‘protective garment’, ‘protective clothing’, ‘garment’ and/or ‘clothing’ are used interchangeably in this application and are considered to have the same or similar meaning. Furthermore, the phrases ‘protective clothing’ includes examples thereof, including for example radiolucent material.

The deficiency testing device according to the invention may, in addition to the use for X-ray protective clothing, also be used for testing bulletproof clothing

In an embodiment of the deficiency testing device according to the invention, the X-ray source is configured to irradiate at least part of a garment positioned on the mannequin thereon to detect deficiencies in the garment.

The X-ray source is preferably configured to irradiate the garment or clothing that is positioned on the mannequin. Any deficiencies, which comprise openings in the X-ray protection of the garment, will allow radiation to pass through for detection by the at least one X-ray detector to identify the deficiency.

In an embodiment of the deficiency testing device according to the invention, the at least one X-ray detector is configured to detect any deficiencies, wherein the deficiencies comprise openings in or reduced thickness of the X-ray protection of the garment.

The X-ray detector preferably is configured to detect radiation from the X-ray source that passes through the garment and identify a deficiency in the X-ray protection thereof due to a difference in the thickness of the protection detected by the detector. In particular, the size and/or location(s) of deficiencies can be determined. This allows the deficiency to be identified and/or allows decisions to be made on whether the garment can be used again or should be discarded.

In an embodiment of the deficiency testing device according to the invention, the device is configured to identify deficiencies in a garment to be tested by detecting, using the X-ray detector, positions or locations at which X-ray radiation emitted by the X-ray source emanates through the garment.

In use of the device, X-ray radiation emitted by the at least one X-ray source can be detected by the at least one X-ray detector when that X-ray radiation penetrates through the X-ray shielding of the garment to be tested. Any differences in thickness of the protection are detected by the at least one X-ray detector and can for example be visualized as different colors or shades of grey in an image. The device according to the invention can in this way be used to identify, by means of the detected X-ray radiation, the positions or locations at which the radiation shielding of the garment to be tested is at least partially insufficient or absent.

In an embodiment of the deficiency testing device according to the invention, the mannequin comprises an outer shell on which the protective garment to be tested is positionable.

An advantage of providing an outer shell is that the garment to be tested is sufficiently supported during scanning. Furthermore, providing an outer shell allows easy positioning of the garment to be tested onto the mannequin. It is noted that the outer shell may be made of any suitable material, which may be a flexible material, a rigid material or a combination thereof. It is preferred that the outer shell has a length that is adaptable to the length of garments to be tested. More preferably the length of the outer shell is longer than the garments to be tested. It is preferred that the outer shell is at least longer than the protective or radiolucent material therein. This achieves that the garment is supported over its entire length during scanning.

It is noted that the outer shell thus extends between the at least one X-ray detector and the at least one X-ray source and, preferably is positioned at a predetermined distance from each of them.

In an embodiment of the deficiency testing device according to the invention, at least part of the outer shell is flexible, preferably inflatable, for stretching a protective garment positioned on the mannequin.

An advantage of providing an at least partially flexible, preferably inflatable, outer shell is that the outer shell during use can be inflated to stretch the clothing to be tested. As a result, the clothing will be substantially straightened. In this case straightened means being devoid of any wrinkles, bends, folds, creases and the like. This increases the visibility of any deficiencies present in the garment, allowing these to be more easily be identified. It is preferred that a (semi-)continuous stream of gas is used during scanning to maintain the straight position of the clothing on the outer shell of the mannequin.

In this respect it is noted that ‘flexible’ means that the mannequin is moveable between an inward position and at least one outward position in which the mannequin is substantially contiguous with the garment to be tested. With regard to the term ‘inflatable’, it means that the mannequin, in the inward position is substantially not inflated, whereas the mannequin in the outward position is at least partially inflated such that it is substantially contiguous with the mannequin.

It is further noted that the term ‘inflatable’ may also indicates that the material is configured to be stretched under pressure from the uninflated or a non-stretched position to an inflated or a stretched position in which the surface area of the material is increased.

Another advantage is that smaller garments, such as neck protection pieces, may more easily be positioned (and secured) on the mannequin. This is especially true if multiple smaller garments are positioned next to each other in the height direction to test them in a single testing operation.

In an embodiment of the deficiency testing device according to the invention, the outer shell is made of a porous or semi-porous material allowing gas, which may be air, nitrogen or another suitable gas, to at least partially permeate through the outer shell.

An advantage of providing a porous or semi-porous material is that, during scanning, gas, such as for example air or nitrogen, can permeate through the outer shell and against the garment. This increases the pressure on the garment and (even further) reduces the risk of wrinkles and the like.

In an embodiment of the deficiency testing device according to the invention, the outer shell is made of a non-porous material that substantially prevents gas permeate through the outer shell.

An advantage of providing a non-porous material is that, during scanning, gas, such as air or nitrogen, can be provided into the mannequin without having to continuously maintain the flow of gas to the mannequin. The mannequin may in such case be provided as a substantially inflatable body. This increases the pressure on the garment and (even further) reduces the risk of wrinkles and the like.

In an embodiment of the deficiency testing device according to the invention, the outer shell is manufactured of a resilient material, preferably a resilient plastic material and more preferably a resilient polycarbonate.

An advantage of a resilient material is that it is inwardly bendable or compressable under pressure and will expand outwardly when the pressure is released. When providing a garment on the mannequin, the outer shell can be inwardly bend or compressed by tightening the garment on the mannequin. After tightening the garment, the resilient material will expand outwardly against the garment, therewith removing wrinkles and creases from the garment.

It is noted that the term resilient should thus also be construed as having an amount of elasticity that allows the material to be bend inward or compressed under pressure of a garment being tightened thereon.

In an embodiment of the deficiency testing device according to the invention, the outer shell is a bellow and/or is shaped as a rib-cage.

An advantage of a bellow is that is can be inflated to press tightly against the inside of the garment.

An advantage of providing the outer shell as a rib-cage shaped shell is that the form of the outer shell closely resembles the shape of a person wearing the garment. This will automatically lead to the garment being contiguous with the outer shell.

In an embodiment of the deficiency testing device according to the invention, the outer shell is manufactured from a substantially rigid material having a substantially human-shaped form.

An advantage of providing a human-shaped outer shell of rigid material is that the position of the garment to be tested is substantially identical with the position of garment on a person during use. The test can thus be performed by screening the garment ‘as if in use by a person’, which approaches test conditions that are as close to reality as possible.

In an embodiment of the deficiency testing device according to the invention, the outer shell is manufactured from a substantially rigid material and comprises a number of inflatable parts that are configured for stretching a protective garment positioned on the mannequin.

An advantage of providing an outer shell of rigid material is that the outer shell can be substantially shaped in the form of a human, which inherently decreases the amount of wrinkles, creases, folds and the like in the garment to be tested. By simultaneously providing some inflatable parts, the garment to be tested can be stretched (even further), thus further reducing the abovementioned risk of wrinkles, creases and the like.

In an embodiment of the deficiency testing device according to the invention, the mannequin comprises a central support that extends in a first direction along a mannequin axis, wherein the first direction preferably is a height direction.

An advantage of a central support is that the outer shell can easily be supported by the central support. This allows a compact and efficient positioning of the mannequin in the housing space.

Another advantage is that the central support may also be used as a housing or protective cover for the X-ray detector or the X-ray source, which may be positioned inside the central support.

A further advantage is that the central support may, in case an inflatable outer shell is used, be provided with or used for supplying gas to inflate the mannequin.

In an embodiment of the deficiency testing device according to the invention, the mannequin is movable in a first direction, which preferably is a height direction, wherein the movement may be performed using compressed air.

An advantage of the abovementioned embodiment is that the mannequin can be positioned at any height, which allows the height to be adjusted to the garment to be tested. For long garments, such as coats, the mannequin can be positioned at a (relatively) higher point than for shorter garments. Another advantage is that a reduced height simplifies placing the garment to be tested on the mannequin, which increases operation speed. It is also ergonomically beneficial for the operator.

In order to simplify the movement of the mannequin in the first direction, the mannequin may be configured to be moved using compressed air. This allows the position to be adjusted relatively quickly and easily.

In an elaboration, the mannequin is moveable in the first direction along the central support, wherein the mannequin is preferably moveable in the first direction using compressed air.

The mannequin can advantageously be moved along the central support, with the central support being the ‘basis’ for the movement. This may for example be performed using compressed air, but may also be performed using mechanical means, such as gears, belts or the like.

In an embodiment of the deficiency testing device according to the invention, the central support is a tubular support.

A tubular support provides a high resistance against buckling. Another advantage is that it provides a high degree of internal space that can be used for positioning elements of the testing equipment, such as the at least one X-ray detector or the at least one X-ray source.

Another advantage is that, if the central support is used to supply a gas to inflate the outer shell of the mannequin, the tubular side wall may be provided with gas outlets. An advantage of a tubular central support is that the openings can then be substantially evenly distributed along the circumference of the support to apply an even pressure to the outer shell of the mannequin. The even surface also allows any other specifically designed pattern of gas outlets that provides an efficient inflation of the outer shell of the mannequin.

In an embodiment of the deficiency testing device according to the invention, the central support comprises one or more gas outlets that are configured to provide gas for inflating the outer shell.

An advantage of providing one or more gas outlets to the central support is that the outlets are positioned close to the outer shell to allow a rapid inflation thereof. Another advantage is that, due to the fact that the outer shell is connected to the central support, the gas outlets can be advantageously positioned with respect to the outer shell to provide a maximum effect during inflation. This reduces the amount of (compressed) gas, such as for example air or nitrogen, that is required for inflating the outer shell. It is noted that the gas outlets preferably emanate underneath the outer shell and are substantially facing the outer shell. This may be directly or under an angle with the mannequin axis.

In an embodiment of the deficiency testing device according to the invention, the central support is a double-walled tubular support, wherein the one or more gas outlets are positioned in an outer wall and wherein a space between an inner and the outer wall comprises a gas flow channel.

It is noted that the term ‘double-walled’ as used in the application also includes ‘tube-in-tube’ designs in which the inner and outer tube are not (fixedly) connected to each other and do not form a single tube.

For completeness sake, it is noted that in this embodiment the outer wall faces the outer shell of the mannequin. An advantage of this embodiment is that the supply of (compressed/pressurized) gas to the mannequin can be efficiently and safely managed. The gas flow is confined to a limited space (i.e. the gas flow channel), thus allowing the flow to be controlled.

Another advantage is that, due to the double-walled support, it is possible to provide a rotatable outer wall, while simultaneously having a stationary (i.e. non-rotatable) inner wall. The at least one X-ray detector (or alternatively the at least one X-ray source) can then be advantageously positioned inside the inner wall (i.e. inside the inner tube formed by the inner wall).

In an embodiment of the deficiency testing device according to the invention, the device comprises a gas source, which may be an air source, a nitrogen source or a source of another suitable gas, that is connected to the gas outlets or, alternatively, connected to the gas flow channel.

An advantage of providing the device with a gas source is that a stand-alone device is achieved that does not require an external gas source. This increases the flexibility of the device during use. It may however also be considered to provide an external gas source if available. It may even be advantageous to, in some cases, provide the device with both a gas source and a connection for connecting an external gas source. It is preferred that the gas source is a source of pressurized or compressed gas.

In an embodiment of the deficiency testing device according to the invention, the gas source is configured to, during use, provide a substantially continuous flow of gas to the gas outlets.

An advantage of providing a substantially continuous flow of gas is that, during scanning, the garment to be tested will be held firmly in place. This increases the scanning accuracy and decreases the risk of failures that arise from wrinkles and the like, which in turn may lead to incorrect judgement of (presence of) deficiencies in the garment. It is preferred that the gas source is a source of pressurized or compressed gas.

In an embodiment of the deficiency testing device according to the invention, the gas source is configured to, during use, provide an intermittent flow of gas to the gas outlets.

An advantage of providing an intermittent flow of gas is that, during screening, the garment to be tested will be held firmly in place while at the same time reducing the amount of gas required to keep the mannequin inflated. This increases the scanning accuracy and decreases the risk of failures that arise from wrinkles and the like, which in turn may lead to incorrect judgement of (presence of) deficiencies in the garment. It is preferred that the gas source is a source of pressurized or compressed gas.

In an embodiment of the deficiency testing device according to the invention, the mannequin comprises a support, for example a cross beam, that extends within the mannequin shell in a second direction, preferably a width direction, that is substantially perpendicular to the first direction.

An advantage of providing a support such as a cross-beam is that the garment can more easily be placed on the mannequin. The support is configured to act as a ‘shoulder section’ of the mannequin. In other words, the support is meant to carry the portion of the garment generally positioned on the shoulders of a person wearing the garment.

Another advantage is that the support also provides an initial stretching of the garment, which reduces the amount of wrinkles, folds and the like.

In an embodiment of the deficiency testing device according to the invention, the device further comprises at least one imaging means, preferably at least one camera, that is positioned facing the mannequin, and that is positioned outside the mannequin, inside the mannequin or both.

An advantage of providing both imaging means and an X-ray source is that both deficiencies in the X-ray shielding of the garment and deficiencies in other parts of the garment may simultaneously be identified.

To that end, the imaging means, which preferably comprise a camera, can be positioned inside the mannequin, outside the mannequin or both. Preferably, the imaging means are positioned near the X-ray source. Depending on the preferences and purposes, the garment may be observed using the imaging means from inside or outside the mannequin or both. In particular, the at least one imaging means allow a visual inspection of the garment in addition to the X-ray based inspection. This also allows damage to other parts of the garment to be identified.

In an embodiment of the deficiency testing device according to the invention, the at least one X-ray source comprises a source housing that substantially surrounds the at least one X-ray source, wherein the source housing preferably is manufactured at least partially from aluminium and/or carbon.

An advantage of providing the at least one X-ray source in a separate, dedicated housing is that it is protected against contamination and/or (impact) damage. It also increases the operational life-time of the device by increasing the operational life-time of the at least one X-ray source.

In an embodiment of the deficiency testing device according to the invention, the device comprising a housing enclosing a housing space in which the mannequin, the at least one X-ray detector and the at least one X-ray source are positioned.

An advantage of a housing is that it provides support for the various components of the device, including control systems and systems to move the X-ray detector and/or the X-ray source and/or the mannequin relative to each other. Another advantage is that the housing provides a closed environment which can be provided with warnings regarding the presence and/or use of X-rays.

It is preferred that the housing is a cabinet-like structure. An advantage thereof is that elements, including a drive motor, a control unit and (graphical) user interfaces can be provided in or on the walls of the housing. In some cases, at least one of the walls may be a double wall having an internal space in which elements or parts of the device can be provided. Such parts may then not be visible in/touchable from the housing to prevent X-ray radiation thereon, while still being protected from outside influences.

In an embodiment of the deficiency testing device according to the invention, the housing comprises a source space in which the at least one X-ray source is positioned, wherein the source space comprises at least one wall manufactured from an X-ray permeable material, such as aluminium or a carbon-based material. The source space is preferably positioned in the housing space, for example at the center of the mannequin. The source space may also be positioned adjacent to the housing space such that the X-ray permeable wall separates the housing space and the source space from each other.

In an embodiment of the deficiency testing device according to the invention, the housing comprises a recloseable opening that provides access to the housing space to selectively provide and remove a protective garment to be tested.

It is preferred that the housing space is accessible by means of an opening, for example a door or set of doors, which provide sufficient room for applying clothing to be tested to the mannequin.

In an embodiment of the deficiency testing device according to the invention, the housing comprises X-ray shielding, wherein the X-ray shielding preferably substantially encloses the housing space.

Providing (additional) X-ray shielding to the housing reduces the risk of accidental exposure to X-ray radiation by users and/or people in the vicinity of the device.

In an embodiment of the deficiency testing device according to the invention, the resealable opening is closeable by closing means, wherein the closing means preferably are X-ray shielded closing means, such as X-ray shielded doors.

An advantage of providing X-ray shielded closing means is that the housing space is completely surrounded by X-ray shielding, which even further improves the safety of the device for personnel. Preferably, the closing means are X-ray shielded doors. More preferably, the X-ray shielded doors are designed such that edges between the doors and the housing are also X-ray shielded, for example by overlapping.

In an embodiment of the deficiency testing device according to the invention, in which the mannequin comprises a central support, end portions of the central support extend beyond the housing space.

An advantage of this embodiment is that the central support is supported by the end portions that extend through the wall. This increases the robustness of the device.

Another advantage is that, by means of the end portion(s), additional elements can be coupled to the central support. This may for example be a gas source, a drive mechanism or other elements of the device. This obviates the need to provide additional connections in the housing space.

In an embodiment of the deficiency testing device according to the invention, a first end portion or the second end portion of the end portions is connected to a drive mechanism for rotatably driving the central support and the mannequin.

The drive mechanism for rotating the mannequin can, by connecting it to an end portion, be advantageously be positioned outside the housing space. Preferably, the drive mechanism is positioned in a separate space in the housing.

In an embodiment of the deficiency testing device according to the invention, the first end portion and/or the second end portion comprises a flange.

The flange or flanges provide additional stability to the central support and reduce the risk of sidelong movement of the central support. In addition, the flange or flanges may be used for connecting a drive mechanism and/or a gas source.

In an embodiment of the deficiency testing device according to the invention, a drive portion, such as a gear or belt, of the drive mechanism is configured to mate with the flange of the first end portion or the flange of the second end portion.

The flange may advantageously be formed as a gear or be formed to support a drive belt of a drive mechanism to provide a small and integrated drive mechanism to rotate the mannequin by rotating the central support.

In an embodiment of the deficiency testing device according to the invention, the first and/or the second flange is provided with a gas flow channel, and wherein a gas source is, preferably via a rotatable coupling, connected to the gas outlets.

An advantage of the flange is that it provides ample space to accommodate a rotatable coupling and a gas flow channel that is operatively connectable to the gas outlets.

In a preferred embodiment, the gas flow channel in the flange is connected to a gas flow channel of double-walled or tube-in-tube tubular support to effectively transfer the gas to the gas outlets and the outer shell.

In an embodiment of the deficiency testing device according to the invention, the housing is provided with transport means, wherein the transport means preferably are wheels.

An advantage of providing transport means is that the device can, contrary to the existing devices, be easily moved to a location at which the clothing or garments to be tested are located. This is particularly advantageous in medical environments, such as hospitals, since the protective clothing in such locations may often not be moved outside a ward and/or the facility. The device according to the invention obviates the need for (re)moving the clothing or garments within or outside the facility by bringing the device to the clothing or garments.

In a further embodiment of the deficiency testing device according to the invention, the wheels are at least partially encased in the housing.

An advantage of arranging the wheels at least partially in the housing is that the height of the device is reduced. As a result, the ergonomy of the device is improved.

In a further embodiment of the deficiency testing device according to the invention, the wheels are positioned at the side walls of the housing, preferably on opposite side walls of the housing.

An advantage of arranging the wheels on the side walls of the housing is that the stability of the device is improved. In addition, the ergonomy can be improved due to the fact that the wheels can be positioned at a position relatively low to the ground. The latter can for example be provided by positioning the wheels relatively high on the side.

In an embodiment of the deficiency testing device according to the invention, the transport means have a drive position, in which the device is transportable, and a blocked position in which transport is substantially prohibited.

An advantage of this embodiment that, during use, movement of the device can be substantially prevented by blocking the transport means in the blocked position. This prevents the device from accidentally moving during scanning and thus increases accuracy. In addition, the safety of the device is increased even further. As soon as transportation is required, the transport means are transferred to the drive position, which allows transportation of the device to a different location.

The transport means, especially in case of wheels, may also be provided as retractable wheels, which allows the device to be transferred from the drive position to the blocked position and vice versa.

In an embodiment of the deficiency testing device according to the invention, the device comprises locking means that are configured to releasably lock the transport means in the blocked position, wherein the locking means are configured to be released by an operator using unlocking equipment.

An advantage is that unauthorized transport of the device is substantially prevented due to the lock position. Only authorized personnel is able to unlock the transport means and subsequently move the device to a different location. This reduces the risk of theft and/or accidental displacement by unauthorized personnel. The locking means are configured to be unlocked using unlocking equipment, which may be a physical key, yet preferably is a keycard or a software solution. A software solution may be an unlock code for unlocking the locking means. It may also be formed by a (software) requirement that an authorized operator logs on to the software and/or a control unit to automatically or manually unlock the locking means.

In an embodiment of the deficiency testing device according to the invention, the device further comprises a drive camera that is positioned, when viewed in a movement direction of the device, on a front side of the device.

An advantage of providing a drive camera is that it increases safety during transport even further. The camera footage may be provided to an operator or other person transporting the device to see what is in front of the device. This is especially relevant if the device is configured to be pushed by an operator to transport it.

In an embodiment of the deficiency testing device according to the invention, the at least one X-ray detector is positioned within the mannequin, and wherein the at least one X-ray source is positioned outside the mannequin.

An advantage of providing the X-ray detector inside the mannequin is that it is substantially protected from (physical) damage. In addition, X-ray detectors often comprise a longitudinal detector which can easily be positioned in for example a central support.

Furthermore, X-ray detectors require relatively little maintenance and therefore do not have to be readily accessible.

In an embodiment of the deficiency testing device according to the invention in which the central support is a tubular support, the at least one X-ray detector is positioned within the tubular support.

An advantage of providing the X-ray detector inside the mannequin is that it is substantially protected from (physical) damage. Especially longitudinally extending detectors can easily be positioned in a tubular support along a central axis thereof. This obviates the need to move them during scanning.

In an embodiment of the deficiency testing device according to the invention, the at least one X-ray source is rotatable around the mannequin.

An advantage of providing an X-ray source that is rotatable around the mannequin is that the mannequin may easily be removed for placement of the garment or for replacement with a different mannequin. As a result, multiple mannequins may be used that are switched to increase the rate of scanning operation.

In an embodiment of the deficiency testing device according to the invention, the at least one X-ray detector is positioned outside the mannequin, and the at least one X-ray source is positioned within the mannequin.

In an alternative, the X-ray source may be positioned inside the mannequin and the X-ray detector may be positioned outside the mannequin.

In an embodiment of the deficiency testing device according to the invention, the at least one X-ray detector is rotatable around the mannequin.

In an alternative in which the X-ray detector is positioned outside the mannequin, the X-ray detector may be rotatable around the mannequin. This provides similar advantages as the abovementioned embodiment in which the X-ray source is rotatable around the mannequin.

In an embodiment of the deficiency testing device according to the invention, the at least one X-ray detector and the at least one X-ray source are both rotatable, wherein, during rotation, the at least one X-ray source and the at least one X-ray detector face each other.

In an even further alternative, both the X-ray detector and the X-ray source are rotatable. In this alternative, the source and detector preferably rotate synchronously with each other such that they remain facing each other during scanning.

In an embodiment of the deficiency testing device according to the invention, the mannequin is rotatable around a mannequin axis that extends in a first direction, wherein the first direction preferably is a height direction.

In a preferred embodiment, the mannequin is rotatable around a mannequin axis. The mannequin axis preferably is the central axis of the mannequin. An advantage of providing a rotatable mannequin is that both the X-ray detector and the X-ray source can, in terms of rotation, be positioned at a fixed position in which they face each other. This allows the garment to be rotated between them to provide the scanning.

Another advantage is that this particular configuration also requires a small amount of space, which reduces the total size of the device. This is beneficial both with respect to costs and with respect to displacement of the device.

In an embodiment of the deficiency testing device according to the invention, the at least one X-ray detector or the at least one X-ray source is provided at a stationary position, and wherein the stationary position preferably is a position on a mannequin axis of the mannequin.

It is preferred that the element (whether it be the X-ray source or the X-ray detector) that is positioned inside the mannequin is provided at a stationary position. This is in respect of rotation as well as movement in the height direction. This obviates the need to supply movement means inside the mannequin, which would increase the complexity of the device. It is advantageous if the stationary position is on the rotation axis of the mannequin since this rotation axis is always provided at a distance of the mannequin, thus reducing the risk of damage to the abovementioned element.

In an embodiment of the deficiency testing device according to the invention, the outer shell and the central support are connected to each other and rotatable around the mannequin axis together.

It is preferred that the outer shell and the central support form a single rotatable unit, since it reduces the complexity of the device. It also allows the drive mechanism to be positioned outside the housing space, thus reducing the risk of damage thereto during use of the device.

Another advantage is that the gas supply for inflating the outer shell can be more easily be established, therewith reducing both cost and complexity of the device.

In an embodiment of the deficiency testing device according to the invention, the X-ray source and/or the X-ray detector are moveable in a first direction, wherein the first direction preferably is a height direction.

In order to scan the entire garment, one of the X-ray source or the X-ray detector needs to be moved along the height direction. Due to the fact that the X-ray source is positioned relatively close to the garment, only a limited field of view can be irradiated at a given point in time. Although this may be solved by increasing both the power/irradiation output of the X-ray source and the distance to the garment, this increases the size of the device.

Instead, it has proven advantageous to move the X-ray source and the X-ray detector relative to each other along to the height direction. This way, the entire length of the garment (viewed in the height direction) can be scanned, while simultaneously providing a relatively small device with a relatively low power X-ray source.

In a preferred embodiment, a scanning operation is provided in a number of subsequent scanning suboperations, wherein each suboperation provides a 360° scan of the garment at a predetermined height, and wherein a screening image is a compilation of the scan results/detection data of all suboperations.

In an embodiment of the deficiency testing device according to the invention, the mannequin comprises a mannequin axis extending in a height direction, wherein the at least one X-ray detector is positioned at a stationary position on the mannequin axis within the mannequin, wherein the mannequin is rotatable around the mannequin axis, and wherein the X-ray source is facing towards the mannequin axis and the at least one X-ray detector and is movable along a height direction.

This embodiment provides a deficiency testing device having a small footprint in terms of required space, while simultaneously allowing an efficient deficiency testing. The device according to this embodiment can be used to test substantially any length and width of garment that is generally used in practice. In addition, it combines advantages of several of the abovementioned embodiments.

In an embodiment of the deficiency testing device according to the invention, the device comprises a drive or drive motor configured to, during use, rotate one or more of the mannequin, the at least one X-ray detector and the at least one X-ray source.

The drive motor may for example be an electric motor, which may be supplemented by a power transfer system, such as a gear system, a belt-drive or another suitable system.

In an embodiment of the deficiency testing device according to the invention, the device comprises a control unit that is configured for, during use, controlling the deficiency testing device, wherein the controlling preferably includes controlling a scanning operation of the deficiency testing device.

It is preferred that the device comprises a control unit to control one or more control actions that may need to be executed during testing. In general, the control unit may be configured to process data from the X-ray detector and, in some cases, to perform subsequent actions on that data.

In an embodiment of the deficiency testing device according to the invention, the control unit is configured to control one or more of:
the position of the at least one X-ray detector, the at least one X-ray source and the mannequin relative to each other;
movement of the at least one X-ray detector and/or the at least one X-ray source in a height direction, wherein the movement preferably is chosen such that the circumference of the garment to be tested is scanned in a number of scanning steps each of which is performed at a different height; and/or
the inflation or stretching of the mannequin; and/or
a position of the mannequin, in particular a height position and/or a depth position, wherein the height is measured in the first direction and the depth position is measured in the third direction, and preferably the movement of the mannequin between a number of predetermined positions.

The control unit may advantageously be used to control the absolute position and/or the relative position of the various elements in the deficiency testing device. A particular advantage is that the control unit can be used to provide an integrated control in which the position of the detector and the source relative to each other and/or relative to the mannequin is combined with the amount of inflation/stretching of the mannequin and the (vertical or height) movement of the detector/source. As a result, a high detailed and precise testing can be performed, leading to more reliable test results. This in turn increases the reliability of the device. It is noted that each of the scanning steps results in a scan image. The scan images may be combined, for example (digitally) stitched, together to a screening image containing the information from all individual scanning steps. It is noted that the terms ‘inflation’ and ‘stretching’ refer (and are synonym) to the movement of the mannequin between an uninflated or a non-stretched position to an inflated or a stretched position in which the surface area of the material is increased.

The number of predetermined positions may for example include a test position, in which the mannequin is positioned in the housing, and an input position, in which the mannequin is positioned at a lower height and/or a shallower depth than in the test position. This allows easier positioning of a garment to be tested on the mannequin.

In an elaboration of the abovementioned embodiment, the control unit may additionally be configured to control the imaging means to perform similar or the same steps as mentioned above. The images of the imaging means may be combined, for example (digitally) stitched, together to an image containing the visual information from all individual imaging steps. The image may also be combined with the screening image to a single comprehensive image containing both the visual and the X-ray detected deficiencies.

In an embodiment of the deficiency testing device according to the invention, the control unit further is configured for receiving and processing detection data from the at least one detector for detecting deficiencies in a garment to be tested.

The control unit can additionally be configured to receive and process detection data to provide aggregated or processed data that may be used to determine whether the garment should be rejected as deficient. It is noted that in an elaboration of this embodiment, the control unit may be a computing device comprising a processor and/or software configured to perform the processing steps.

In an embodiment of the deficiency testing device according to the invention, the processor and/or the software may be configured for processing steps, wherein the processing steps may comprise one or more of:
combining the detection data from each scanning step together to obtain a screening of the garment to be tested;
identifying the presence, and preferably the position of, deficiencies in the garment.
evaluating the detection data to identify deficiencies in the garment;
calculating the percentage of deficiencies in the garment relative to its surface and/or the absolute surface area and location of the deficiencies; and
comparing the percentage and/or the absolute surface area of deficiencies to a deficiency threshold.

Rejecting the garment if a percentage and/or an absolute surface area of deficiencies exceeds a deficiency threshold.

Advantage of this embodiment is that the testing is performed in a structured, efficient manner. Another advantage is that, due to the control unit being configured for the abovementioned processing step(s), a stand-alone device is achieved.

The detection data, which often comprises a scan image from each separate scanning step, may be combined into a screening image comprising the data of all scan images.

It is noted that in an elaboration of this embodiment, the control unit may be a computing device comprising a processor and/or software configured to perform the processing steps.

In an embodiment of the deficiency testing device according to the invention, the control unit may comprise software that is configured to be executed by the control unit or a processor thereof, and wherein the software is configured to perform one or more of the receiving and processing steps.

In an embodiment of the deficiency testing device according to the invention, the control unit may be a computing device or may be incorporated therein.

The control unit may be a computing device or may be incorporated therein, which allows more complex processing steps, such as image processing, integrated source and/or detector control, and/or calculating deficiency decisions and/or advice.

In an embodiment of the deficiency testing device according to the invention, the control unit and/or the computing device may be configured for:
positioning the device, preferably the X-ray source and/or the X-ray detector thereof, in a first scanning position in which the X-ray source and the garment to be tested are, when viewed in the first direction, positioned relative to each other at a first height;
X-ray scanning the garments to be tested over a 360° arc in the first scanning position;
positioning the device, preferably the X-ray source and/or the X-ray detector thereof, in a subsequent scanning position in which the X-ray source and the garment to be tested are, when viewed in the first direction, positioned relative to each other at a second height;
X-ray scanning the garments to be tested over a 360° arc in the subsequent scanning position; and
repeating the abovementioned positioning and scanning steps to scan the garment to be tested over its entire height; and
optionally stitching the result from each scanning step together to obtain screening image of the garment;

An advantage of the abovementioned embodiment is that the number of X-ray sources and/or X-ray detectors can be limited due to the fact that the garment is scanned in a step-wise fashion. Preferably, the computing device is provided with stitching software that allows the separate scans for the various heights to be combined into a single view including all detected/identified deficiencies. Due to the limited number of X-ray detectors and/or sources required, the manufacturing and/or maintenance costs of the device are relatively low. The limited number also results in operational costs being relatively low.

In an embodiment of the deficiency testing device according to the invention in which the device comprises imaging means, the control unit and/or the computing device may be configured for mapping the visual image to the screening image to provide an aggregated image, preferably an aggregated image configured for at least one of visual identification archiving, detecting and/or storing outer visual defects and detecting and/or storing medically relevant contamination, such as dirt. This step may optionally also be combined with one or more stitching steps in which relevant images are being combined in a single comprehensive image.

An advantage is that a comprehensive image is obtained that can be used for various different purposes.

In an embodiment of the deficiency testing device according to the invention, the control unit and/or the computing device may be configured for:
receiving the scanning data from the detector;
optionally, storing the scanning data in a memory;
stitching the result from each scanning step together to obtain screening image of the garment;
evaluating the screening image using evaluation software to identify deficiencies in the garment;
calculating the percentage of deficiencies in the garment relative to its surface and/or calculating the absolute surface area and location of the deficiencies; and
comparing the percentage and/or the absolute surface area of deficiencies to a deficiency threshold; and
optionally indicating a ‘pass’ or ‘fail’ message to an operator, for example by means of an audible or visual message; and/or optionally displaying an image of the garment to be tested including indicators indicating identified defects in the garment.

An advantage of providing a control unit and/or a computing device that is configured to perform the abovementioned steps is that a semi-automatic or automatic evaluation of the deficiencies can be carried out. In addition, the data may be stored for later use in a memory, which allows retrospective analysis of multiple garments to improve the garments. This is mainly due to the fact that the screening images can be used to determine trends in wear and/or damage of the garments, which information may be used by a manufacturer to selectively improve the garments based on these results.

Another advantage is that the operator will, in a relatively short time, receive a message containing a decision or advice with regard to whether a garment is too damaged for further use. The storage of the images in the memory allows an operator to review the decision or advice in the message of the device. It also can be used for quality control purposes and/or for an audit at a later moment in time.

In an embodiment of the deficiency testing device according to the invention, the device comprises input means and/or a user interface, preferably a graphical user interface, that allow a user to interact with the control unit.

An advantage of providing input means and/or a user interface is that the device can be monitored and/or operated by an operator. In particular, the operator may, using the input means, evaluate the testing results and/or provide relevant input to the device regarding the garment to be tested.

Another advantage is that, in case the input means comprise graphical display means, the input means may be used to show camera footage of a drive camera as mentioned in one of the previous embodiments. Furthermore, another advantage is that the input means may be used to unlock the locking means, for example by inserting a code and/or scanning a picture.

In an embodiment of the deficiency testing device according to the invention, the device may comprise a shutter element that is configured to selectively interrupt the X-rays emitted by the X-ray source, wherein the shutter element comprises a shutter and preferably also a shutter housing.

An advantage of a shutter element is that the X-rays from the X-ray can selectively be interrupted without having to shut down the X-ray source. This provides an even further increased safety.

Another advantage is that the shutter element also functions as a dose regulator for regulating the amount of X-rays that are irradiated on the garment (and the mannequin positioned beneath it).

It is noted that the shutter element, and specifically the shutter thereof, is transferrable between a closed or interrupting position in which the X-rays from the X-ray source are substantially blocked and an open or uninterrupted position in which the X-rays from the X-ray source are not interrupted.

The operation of the shutter element may be performed using the control unit.

In an embodiment of the deficiency testing device according to the invention, the control unit, or alternatively the computing device, is configured to identify a front and a back of the garment to be tested.

An advantage of being able to identify the front and the back of the garment is that deficiencies that are present in the front are more important than deficiencies in the back of the garment. This is mainly due to the fact that most radiation during use of the garment are directed to the front of the garment.

In a further embodiment of the deficiency testing device according to the invention, the control unit, or alternatively the computing device, is further configured to:
mark identified deficiencies as ‘front’deficiency or ‘back’deficiency;
calculate the percentage and/or the absolute surface area, optionally including location, of ‘front’ deficiencies in the garment relative to its front surface
calculate the percentage and/or the absolute surface area, optionally including location, of ‘back’ deficiencies in the garment relative to its back surface; and
compare the percentage and/or the absolute surface area of ‘front’ deficiencies to a front deficiency threshold and compare the percentage and/or the absolute surface area of ‘back’ deficiencies to a ‘back’ deficiency threshold,
wherein the front deficiency threshold is lower than the ‘back’ deficiency threshold.

An advantage of providing different thresholds for the front and the back side of the garment is that a lower threshold can be used for the front side of the garment. This side is generally more exposed to radiation than the back side, which means that the amount of damage to the front side should be lower to compensate for the increased amount of radiation received.

In an embodiment of the deficiency testing device according to the invention, the mannequin may be displaceable in a third direction, wherein the third direction is a direction that extends substantially perpendicular to the first and the second direction.

The third direction preferably is a depth direction, whereas the second direction is a width direction that is perpendicular thereto. An advantage of displacability of the mannequin in the third direction is that it can be moved at least partially outwards relative to the housing, which makes it easier for an operator to position a garment on the mannequin. This increases the speed with which an operator can work and thus the amount of garments that can be scanned in a predetermined time period. It is also ergonomically beneficial for the operator.

In a preferred embodiment, the mannequin can both be displaced in the first direction (i.e. lowered) and the third direction (i.e. outward), such that it can be at least partially be positioned outside the housing in which the mannequin during scanning is provided. This significantly reduces the time and effort for an operator to position a garment to be tested on the mannequin.

In an embodiment of the deficiency testing device according to the invention, the mannequin is removably positioned on a support structure, such that it is exchangeable for a further mannequin, and preferably the one of the at least one X-ray source and the at least one X-ray detector that is positioned within the mannequin is connected to the support structure.

An advantage of a removable mannequin is that it allows ‘hot swapping’ of the mannequin and the garment to be tested. This means that a mannequin can be provided with a garment to be tested and subsequently be positioned on the support structure to perform the actual testing. As a result, a first garment can be tested on a first mannequin, while simultaneously a (second) garment can be prepared for testing on a second mannequin. The support structure preferably is a support on which the mannequin can easily be provided, such as a bar or a pole or another suitable structure.

In an embodiment of the deficiency testing device according to the invention, the device may further comprise a UV-source that is configured to remove, or at least reduce, the amount of viruses and bacteria on the mannequin and/or the garment positioned thereon.

The UV-source is preferably positioned such that the UV-radiation extends towards the mannequin and/or the garment positioned thereon. The UV-source may thereto be for example positioned inside the mannequin or outside the mannequin. It may for example also be positioned next to the at least one X-ray source and configured to be displaced therewith.

The invention also relates to a system for deficiency testing of X-ray protective garments, the system comprising:
at least one deficiency testing device for deficiency testing of X-ray protective garments according to the invention; and
a computing device with a processor; and
a memory for storing at least a part of the detection data.

The system according to the invention has similar effects and advantages as the deficiency testing device according to the invention. It is noted that the embodiments described for the deficiency testing device according to the invention can freely be used and/or combined in the system for deficiency testing according to the invention.

An advantage of the system according to the invention is that it can be expanded to include several other elements that may provide additional advantages and synergies. In particular the storage of the testing data will allow a more precise ‘track record’ of testing results, which is usable in logistics management. It may for example lead to preventive ordering, in which new clothing is ordered when, based on the aggregated testing results, the old one is expected to be deficient. It may also be used to identify which parts, if any, of the clothing is more sensitive to damage than other parts. This data may then be used to improve the (newly developed) clothing. Furthermore, it can for example be used in quality control audits.

In an embodiment of the deficiency testing system according to the invention, the system may be provided with communication means or (digital) connection means to communicate or connect with external systems.

An advantage of providing communication or connection means is that the device can be integrated in a broader system, such as a hospital network. This will for example allow the storage and/or transfer of testing data to separate locations within the network.

In an embodiment of the deficiency testing system according to the invention, the system comprises at least one garment to be tested, wherein the garment to be tested comprises an ID-element, such as an ID-tag, a barcode, an RFID-tag and/or an NFC-tag.

An advantage of providing an ID-element, preferably an ID-tag or a barcode, to the clothing, is that information regarding the clothing can be provided and stored. This may for example contain an origin of the clothing, such as the department from which the clothing was derived. It may however also concern historical data of the clothing, such as the time of use, the previous deficiency test results and/or the deficiency development over time. This provides may support logistic processes and preventive maintenance as it allows a logistics manager to anticipate the operational lifetime of similar clothing and order new clothing if the old clothing nears end-of-life.

The invention also relates to a method for deficiency testing of X-ray protective garments, the method comprising:
providing a deficiency testing device according to the invention;
providing a garment to be tested to the device; and
operating the device by deficiency testing the garment using X-ray.

The method according to the invention has similar effects and advantages as the deficiency testing device and system according to the invention. It is noted that the embodiments described for the deficiency testing device and system according to the invention can freely be used and/or combined in the method for deficiency testing according to the invention.

In an embodiment of the deficiency testing method according to the invention, the step of providing the garment to tested to the device comprises one or more of the steps of:
opening the door;
positioning garment to be tested in the device, preferably on the mannequin;
identifying garment by identifying the ID-element attached thereto;
checking, by an operator, free rotation of the at least one X-ray source, the at least one detector and/or the mannequin relative to each other; and/or
closing the door.

An advantage is that, using the abovementioned steps, the correct positioning of the garment on the mannequin and freedom of movement is achieved. This improves the testing efficiency and prevents any delays in the testing process.

Another advantage is that, when the garment is positioned on the mannequin by an operator, the operator is aware of any folds, bends or wrinkles and is able to take these into account when evaluating the testing data.

A further advantage is that, by the steps of positioning and/or checking, a fixed or starting point for the rotation can be created, which ensures that the rotational movement substantially always leads to the scan-image being displayed on the interface, such as a screen, in substantially the same way. This increases reliability and operating speed.

In an embodiment of the deficiency testing method according to the invention, the step of positioning garment to be tested on the device comprises one or more of the steps of:
inflating and/or stretching the mannequin;
checking the mannequin, preferably checking the inflated mannequin, to determine whether the garment is positioned substantially straight on the mannequin.

An advantage of checking the garment is that any possible sources for defects or failures during testing is substantially prevented. As a result, the scanning of unwanted double layers of cloth or fabric is substantially prevented.

In this respect, it is noted that the term ‘straight’ is considered to mean free of wrinkles, bends, folds or other dispositions that may interfere with the scanning operation. It is further noted that the step of ‘inflating or stretching the mannequin’ is also meant to include ‘inflating or stretching parts of the mannequin that are inflatable’. The terms ‘inflating’ and ‘stretching’ in this application should be read as ‘transferring the mannequin from a first, preferably non-inflated or non-stretched position, to a second, preferably inflated or stretched, position in which the circumference of the mannequin is moved at least partially radially outwards compared to the first position.

In an embodiment of the deficiency testing method according to the invention, the step of operating the device comprises the steps of:
performing a scanning operation; and
processing the scanning data; and
rejecting the garment if a percentage and/or an absolute size of deficiencies exceeds a deficiency threshold.

An advantage of the abovementioned embodiment is that the testing efficiency is increased, because the margin of error (in terms of incorrect decisions) is reduced. This is mainly due to the fact that a more detailed view of deficiencies is provided by scanning only the fabric of a single side of the garment. As a result, the amount of false positives and false negatives is significantly reduced. In addition, it allows users or operators to more specifically determine during the method steps whether the garment is defective. It is noted that the deficiencies may also be determined (and subsequently judged) based on an absolute number of deficiencies, the location of deficiencies or combinations of the abovementioned and/or the mentioned deficiency measurements.

In an embodiment of the deficiency testing method according to the invention, the step of performing a scanning operation comprises one or more of the steps of:
positioning the device in a first scanning position in which the X-ray source and the garment to be tested are positioned relative to each other at a first height;

X-ray scanning the garments to be tested over a 360° arc in the first scanning position;
positioning the device in a subsequent scanning position in which the X-ray source and the garment to be tested are positioned relative to each other at a second height;

X-ray scanning the garments to be tested over a 360° arc in the subsequent scanning position;
repeating the abovementioned positioning and scanning steps to scan the garment to be tested over its entire height.

An advantage of the abovementioned embodiment is that it provides an efficient method of testing, while simultaneously requiring relatively small space for the device. In addition, by testing in several scanning steps, a less powerful X-ray source can be used for the scanning operation. This reduces risks and increases efficiency, while simultaneously increasing the testing efficiency.

In an embodiment of the deficiency testing method according to the invention, the step of performing the scanning operation may comprise the step of, during identifying of the garment, retrieving previous scan data and/or a previous screening image. It may further comprise the step of positioning the device in a scanning position in which the X-ray source is directed to a section of the garment that was identified in the previous scan data and/or the previous screening image as containing one or more deficiencies. It may also comprise the step of scanning said section before scanning other sections and determining, based on the scan result of said section, whether to reject the garment.

In an embodiment of the deficiency testing method according to the invention, in which the device comprises imaging means, the step of performing the scanning operation may additionally or alternatively comprise the step of:
positioning the device in a first scanning position in which the imaging means and the garment to be tested are positioned relative to each other at a first height;
imaging the garments to be tested over a 360° arc in the first scanning position;
positioning the device in a subsequent scanning position in which the imaging means and the garment to be tested are positioned relative to each other at a second height;
imaging the garments to be tested over a 360° arc in the subsequent scanning position;
repeating the abovementioned positioning and scanning steps to scan the garment to be tested over its entire height.

An advantage of the imaging means is that they can provide a visual image of the (outside of the) garment to be tested. This allows detection of physical damage and/or pollution of the garment, which may be used as an additional testing criterium to determine whether a garment remains useable.

In an embodiment of the deficiency testing method according to the invention, in which the device comprises a UV source, preferably a UV light, the step of performing the scanning operation may comprise the step of cleaning the garment using UV light to at least partially remove bacteria, mould and/or viruses.

In an embodiment of the deficiency testing method according to the invention, the step of processing the scanning data comprises one or more of the steps of:
sending the scanning data from the detector to a control or processing unit;
storing the scanning data in a memory;
stitching the result from each scanning step together to obtain a screening image of the garment;
evaluating the screening image using software to identify deficiencies in the garment;
calculating the percentage and/or an absolute size, preferably including location, of deficiencies in the garment relative to its surface; and
comparing the percentage and/or an absolute size of deficiencies to a deficiency threshold.

An advantage of this embodiment is that it provides a structured and simple approach for deficiency testing X-ray protective clothing. In particular the combination of the steps of stitching, calculating and comparing allow an efficient evaluation of whether clothing to be tested can be approved or needs to be rejected. As a result, the margin of error in testing is significantly reduced.

It is noted that the result of a scanning step is a scan image that is a partial view of the garment and the mannequin provided by irradiation. The sum of the scan images provides a screening image that provides a view of the entire garment including all deficiencies (and its locations). In an embodiment of the deficiency testing method according to the invention, the steps of performing the scanning operation and processing the scanning data are performed substantially simultaneously.

It is preferred that the data received from the X-ray detector is processed during the testing operation to provide a real-time feedback to an operator or user of the device. This allows the user or operator to make an evaluation of the garment to be tested even during testing.

In an embodiment of the deficiency testing method according to the invention, the method may also include the step of locking the doors of the device after the step of positioning the garment and/or after the step of closing the doors. It also may include the step of unlocking the doors and removing the garment after completion of the test process, that is after the step of processing the data.

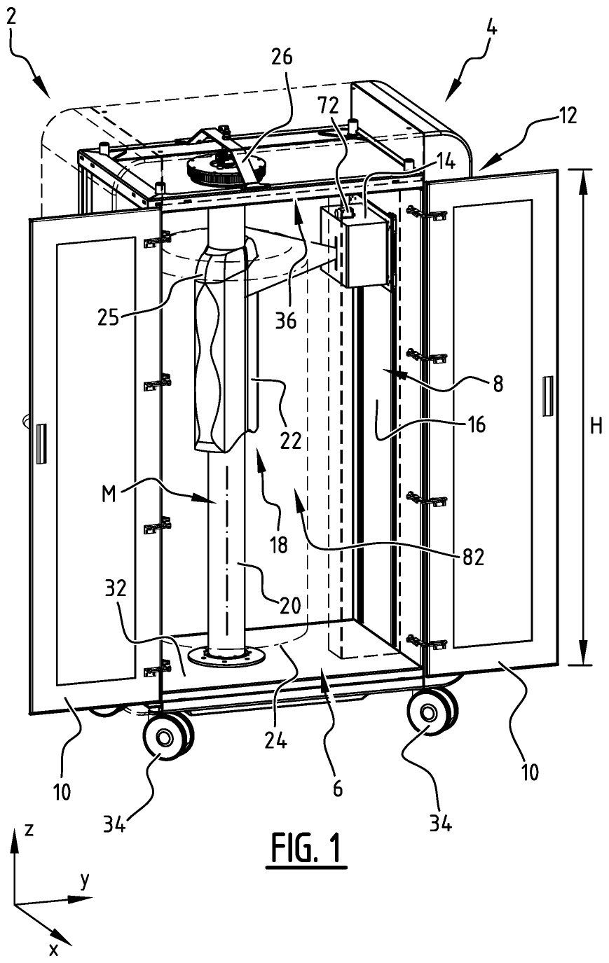

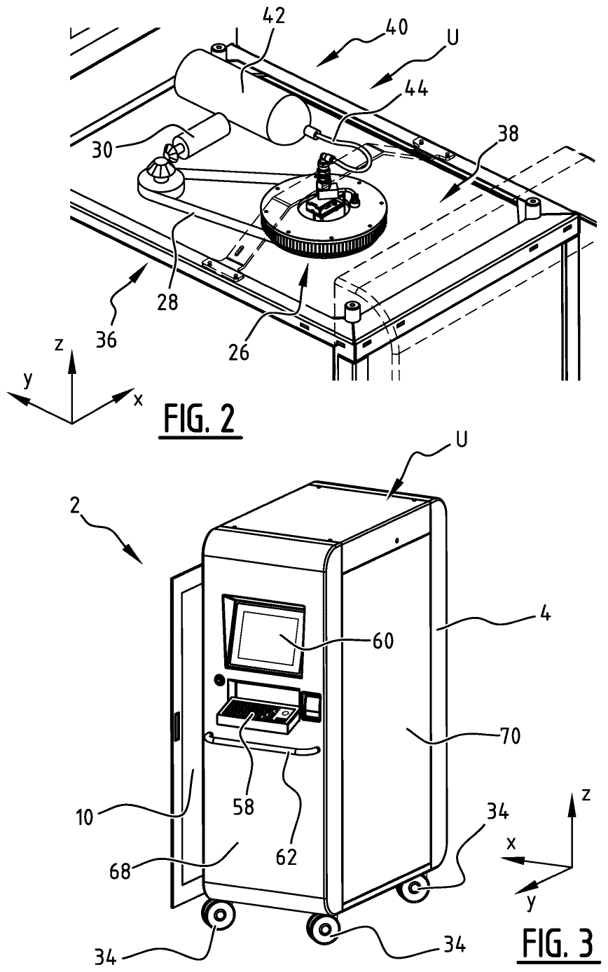

In an embodiment of the deficiency testing method according to the invention, method may further include the steps of starting the device by an operator logging in to the device using access means to allow the operator to operate the device and/or locking the device in a standby or locked state by an operator logging off from the device using the access means.
In an example of deficiency testing device 2, device 2 comprises housing 4 having housing space 6 that is accessible through opening 8. Opening 8 is in this example closeable with double doors 10 provided in side wall 12 of housing 4 of device 2. Clearly visible in housing space 6 of housing 4 is X-ray source 14, which in this example is moveably mounted on housing space side wall 16. X-ray source 14 is moveable in a vertical or height direction z over a predetermined height H.
Housing space 6 further includes mannequin 18, which in this example comprises central support 20 and outer shell 22 that is connected to central support 20. Outer shell 22 is moveable between a non-inflated or non-stretched position and an inflated or stretched position in which the circumference of outer shell 22 is positioned radially outward relative to the position in the non-inflated/non-stretched position. Outer shell 22 can therefore be indicated as flexible, preferably inflatable or stretchable. A garment 24 (provided in dashed lines in FIG. 1) can be positioned on mannequin 18, and is supported by inflatable outer shell 22. In use, outer shell 22 will be inflated (not shown) to stretch garment 24 to remove any wrinkles, folds and bends from garment 24. Mannequin 18 may also comprise a second support 25, in this example a crossbeam, that extends perpendicular to central support 20 and provides a shoulder portion for outer shell 22 and, when in use, for garment 24 to be tested.
X-ray source 14 faces mannequin 18 and is capable of irradiating mannequin 18 with X-ray radiation. Due to the fact that X-ray source 14 is moveable in height direction z, X-ray source 14 can be positioned at different heights to irradiate a particular part of mannequin 18 at a given height.
Central support 20 of mannequin 18 is in this example rotatable around mannequin axis M, which allows garment 24 to be irradiated around its entire circumference during testing. Central support 20 in this example comprises flange 26, which is provided with belt 28 (see FIG. 2). Belt 28 is in turn connected to motor 30, which in this example is electric motor or drive motor 30.
Central support 20 of mannequin 18 is also rotatably provided in a bearing at a lower end thereof. In this example, though not shown, the lower end of central support 20 extends through and beyond floor 32 of housing space 6. Flange 31 extends parallel to floor 32 on the outside of housing space 6 to maintain central support 20 in place. Central support 20 may however also be kept in place using other suitable means. Deficiency testing device 2 is further provided with wheels 34 that allow deficiency testing device 2 to be moved to a location at which garments or clothing to be tested is present.

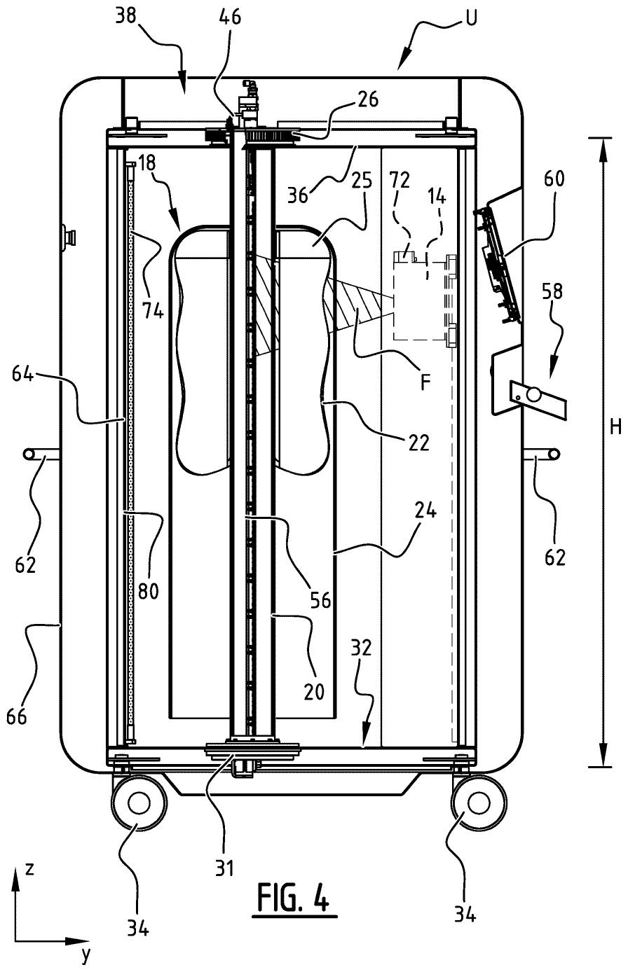

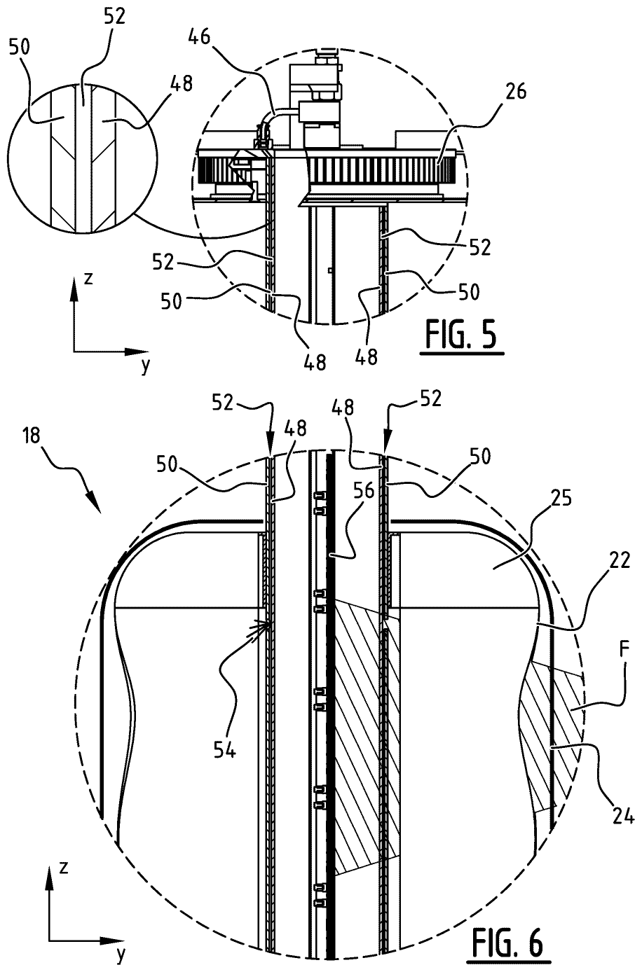

In a more detailed view of the upper section U of the example of deficiency testing device 2 (see FIG. 2), flange 26 of central support 20 can clearly be seen. Central support 20 extends through and beyond ceiling 36 of housing space 6. Flange 26 in this example is a toothed belt 26 that is connected to drive motor 30 by means of belt 28. This allows mannequin 18 to be rotated around mannequin axis M. Upper section U is enclosed in separate space 38 in housing 4.
Deficiency testing device 2 in this example further comprises air supply system 40 that is configured to supply gas for inflating outer shell 22 of mannequin 18. In this example, air supply system 40 comprises air supply 42 which in this case is configured to supply compressed air. In other examples, the air supply may be positioned outside device 2 and/or the air may be another suitable gas. Air supply 42 is connected, via conduit 44, to rotatable coupling 46 that is provided on flange 26 (see FIG. 5). Air supply system 40 is in this example further provided in tubular central support 20. Tubular central support 20 in this example comprises a tube-in-tube support having inner tube 48 and outer tube 50 that together define gas flow channel 52 in between. Outer tube 50 is provided with gas outlets 54 that emanate underneath outer shell 22 (see FIG. 6). Inner tube 48 is a closed tube that is configured to guide the flow of, in this example, compressed air. Other suitable gases may also be used for inflating mannequin 18. It is noted that outer tube 50 is connected to flange 26 and is rotatable thereby. Inner tube 48 is also connected to (rotatable) flange 26. As a result, the supply gas during use of deficiency testing device 2 is possible even during rotation of outer tube 50 by means of rotatable coupling 46.
In this example, deficiency testing device 2 further comprises X-ray detector 56, which in this example is an elongated X-ray detector 56 that extends within inner tube 48 over a predetermined length. In this example, X-ray detector 56 extends collinear with mannequin axis M. X-ray detector 56 in this example is stationary, which means it is neither configured to rotate nor configured to be moveable in height direction z. X-detector 56 in this example extends over substantially the entire height H along which X-ray source 14 is moveable.
Deficiency testing device 2 is further provided with input means 58, which in this case is a keyboard 58, that allows an operator to provide input to deficiency testing device 2 (see also FIGS. 3 and 4). In addition, graphical user interface 60, in the form of screen 60, is provided to allow an operator to interact with deficiency testing device 2. Deficiency testing device 2 further also includes handles 62 that allow deficiency testing device 2 to be moved to different locations.
In order to provide additional protection against radiation, housing 4 of deficiency testing device 2 is further provided with X-ray shielding 64, which in this example is provided inside side walls 12, 66, 68, 70. More specifically, in this example X-ray shielding is applied (directly) on an outside of housing space side walls 16, 32, 36, 80, 82. In this example, doors 10 are also provided with additional X-ray shielding (not shown).
Optionally, deficiency testing device 2 may comprise imaging means 72 and/or UV source 74. Imaging means 72 are used to, in addition to scanning for deficiencies in the X-ray protection, scan for physical signs of damage or pollution that may be of relevance to the decision whether a garment is discarded or can remain in use. The imaging means 72 are preferably positioned in housing 4 in such a manner that it can be used to visualize the outer layers of the garment to be tested. In this example, imaging means 74 are positioned near X-ray source 14 and are movable therewith. UV source 74, which in this example is UV-C source 74, and more particularly UV-C lamp 74, is employed to clean the garment to be tested by irradiating the garment with UV-C light. Preferably, UV source 74 is operationally coupled to X-ray source 14 in such a manner that UV source 74 is only switched on at the moment that X-ray source 14 is switched on. Optionally however, UV source 74 can be uncoupled form X-ray source 14 such that it can be used for a (separate) cleaning step, in which garment 24 is irradiated for a limited period of time to clean garment 24 by at least partially destroying bacteria, viruses and/or mould. In this example, UV-C source 74 is positioned in housing space 6 across from the X-ray source 14.
In use of deficiency testing device 2, deficiency testing device 2 is moved using wheels 34 and handles 62 to a test location at which garment(s) 24 to be tested are located. If arrived at the test location, garment 24 is positioned on mannequin 18 by an operator. After positioning garment 24, the operator activates air supply 40 to inflate outer shell 22 of mannequin 18 to stretch garment 24 on outer shell 22 for removing wrinkles, bends, folds etcetera. The operator may check whether garment 24 is positioned correctly before closing doors 10 to close off housing space 6. Otherwise, the operator will correct the errors in positioning and then close doors 10. It is preferred that, before starting operation, doors 10 are locked. X-ray testing is then started by the operator.
During testing operation, X-ray source 14 irradiates a first section of mannequin 18 and garment 24. Any deficiencies, which are openings in the X-ray protection of garment 24, will be detected by the centrally positioned X-ray detector 56 and subsequently shown to the operator, for example using graphical interface 60. In most cases, the detection data including the deficiencies is processed by software and/or a processor in order to provide a test result at least including a scan image to the operator. After scanning a first section, X-ray source 14 is moved in height direction z to a subsequent position. Depending on the starting point of the testing (i.e. at the highest or the lowest point), X-ray source 14 is moved upwards (from the lowest starting point) or downwards (from the highest starting point) to irradiate the subsequent section.
During testing of each section, mannequin 18 is rotated around mannequin axis M, to expose each part of the circumference of garment 24 to irradiation of X-ray source 14. This allows a complete test to be performed on each part of garment 24. It is noted that in this example X-ray source 14 is stationary. As a result, each section is tested for deficiencies around its entire circumference before moving to a subsequent section. If all sections of garment 24 (viewed along its height) are tested by scanning with X-ray radiation, the various scans may be combined to a screening image and/or a complete test report of entire garment 24. Based on for example a percentage and/or a location of deficiencies detected, garment 24 may be rejected or approved for further use.
Optionally, when using UV source 74, garment 24 is also irradiated by UV-C light at the same time garment 24 is irradiated with X-ray radiation.

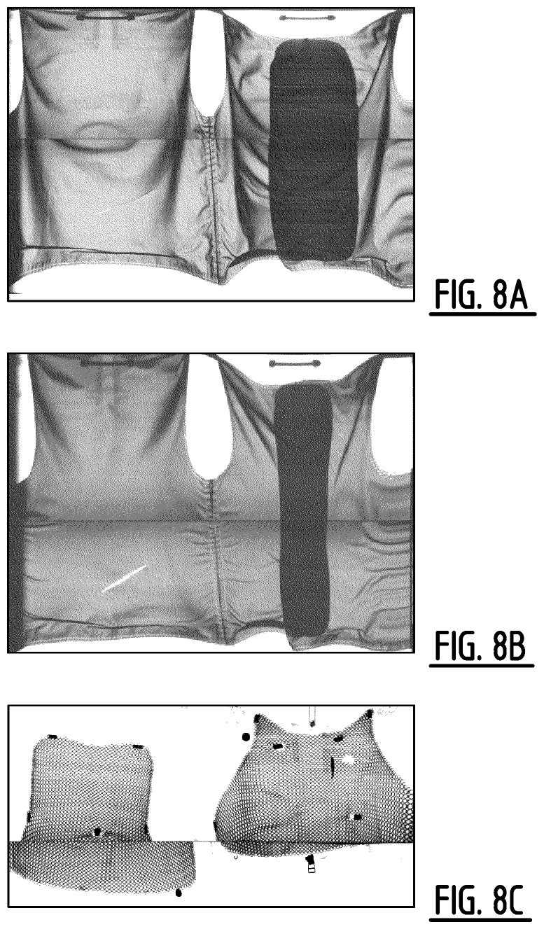

Examples of a scan image (see FIGS. 8a, 8b, 8c) show that the use of a deficiency testing device according to the invention allows a single side of a garment to be scanned and shown. In a first example of a scan image (see FIG. 8a), it can be seen that damage to the garment, in this case a tear in the protective garment, is clearly visible in the scan image. In a second example (see FIG. 8b), an expandable mannequin was used. The mannequin was radially expanded in an outward direction relative to the central axis, which provides an additional stretching force on the garment. This provides an additional effect of removing any wrinkles.

In a third example (see FIG. 8c), a bullet-proof garment was tested in a deficiency testing device according to the invention. It was found that this also provided a clear view of any damage to the garment, and in particular to the protective material therein. The upper left corner of FIG. 8c clearly shows damage (in the form of a hole) in the protective material. Therewith, it is shown that the device according to the invention can also be applied for protective garments such as bullet-proof vests and the like.

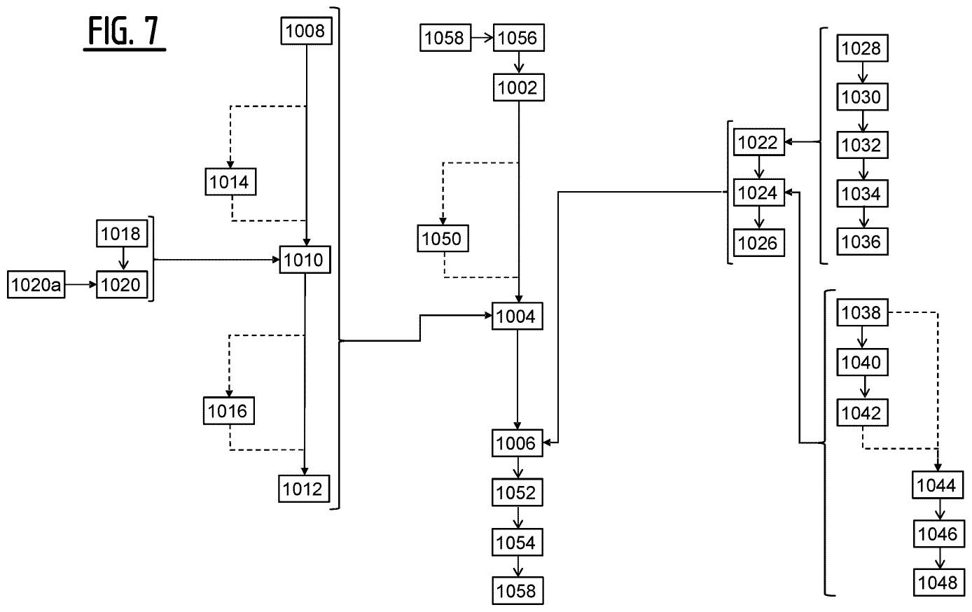

In an example of method for deficiency testing of X-ray protective garments 1000 according to the invention (see FIG. 7), method 1000 comprises three main steps. A first step is providing 1002 a deficiency testing device according to the invention. The other two steps are providing 1004 a garment to be tested to the device and operating 1006 the device by deficiency testing the garment using X-ray.

The main steps may comprise one or more substeps, which may or may not be performed during testing. Providing 1004 the garment to be tested to the device in this example comprises the steps of opening 1008 the door, positioning 1010 garment to be tested in the device and closing 1012 the door. Optionally, method 1000 also comprises the steps of identifying 1014 garment by identifying the ID-element attached thereto and/or checking 1016, by an operator, free rotation of the at least one X-ray source, the at least one detector and/or the mannequin relative to each other.

Furthermore, in this example the step of positioning 1010 the garment to be tested on the device comprises one or more of the steps of inflating/expanding 1018 the mannequin and/or checking 1020 the mannequin, preferably checking the inflated/expanded mannequin, to determine whether the garment is positioned substantially straight on the mannequin. The latter step may optionally also comprises the further optional step of straightening 1020a the garment by the operator when the mannequin is inflated.

In this example, the step of operating 1006 the device comprises the optional steps of performing 1022 a scanning operation, processing 1024 the scanning data, and rejecting 1026 the garment if a percentage of deficiencies exceeds a deficiency threshold. Alternatively or additionally, the step of rejecting 1026 may also take place based on the (absolute) size and/or the location/position of the deficiency/deficiencies that are detected in the test. The steps of performing 1022 and processing 1024 are depicted as sequential in this example, yet may also be performed simultaneously. Performing the scanning operation 1022 in this example also comprises one or more of the optional steps of positioning 1028 the device in a first scanning position in which the X-ray source and the garment to be tested are positioned relative to each other at a first height and X-ray scanning 1030 the garments to be tested over a 360° arc in the first scanning position. Subsequently, the steps of positioning 1032 the device in a subsequent scanning position in which the X-ray source and the garment to be tested are positioned relative to each other at a second height and X-ray scanning 1034 the garments to be tested over a 360° arc in the subsequent scanning position. The optional method steps further comprise repeating 1036 the abovementioned positioning and scanning steps to scan the garment to be tested over its entire height.

Similarly, processing 1024 the scanning data may comprises one or more of the optional steps of sending 1038 the scanning data from the detector to a control or processing unit, storing 1040 the scanning data in a memory and stitching 1042 the result from each scanning step together to obtain full screening image of the garment. Subsequently, the processing 1024 may also comprise the optional steps of evaluating 1044 the screening image using software to identify deficiencies in the garment, calculating 1046 the (absolute) size and/or the percentage and/or the location of deficiencies in the garment relative to its surface and comparing 1048 the (absolute) size and/or the percentage and/or the location of deficiencies to a deficiency threshold.

Method 1000 may optionally also include steps that (further) increase the safety, including the optional steps of locking 1050 the doors of the device after providing 1004 (or positioning 1010) the garment and/or closing 1012 the doors and unlocking 1052 the doors and removing 1054 the garment after completion of the test process.

In addition, method 1000 may also include the steps of starting 1056 the device by an operator logging in 1058 to the device using access means to allow the operator to operate the device.

The present invention is by no means limited to the above described preferred embodiments and/or experiments thereof. The rights sought are defined by the following claims within the scope of which many modifications can be envisaged.

1. Deficiency testing device for deficiency testing protective garments, preferably x-ray protective garments, comprising:
a mannequin configured to support a protective garment to be tested;
at least one X-ray source; and
at least one X-ray detector;
wherein one of the at least one X-ray source and the at least one X-ray detector is positioned within the mannequin and wherein the other of the at least one X-ray source and the at least one X-ray detector is positioned outside the mannequin.

2. Deficiency testing device according to claim 1, wherein the mannequin comprises an outer shell on which the protective garment to be tested is positionable.

3. Deficiency testing device according to claim 2, wherein at least part of the outer shell is flexible, preferably inflatable, for stretching a protective garment positioned on the mannequin.

4. Deficiency testing device according to claim 3, wherein the outer shell is made of a porous or semi-porous material allowing gas, preferably air, to at least partially permeate through the outer shell.

5. Deficiency testing device according to any one of the preceding claims, wherein the mannequin comprises a central support that extends in a first direction along a mannequin axis, wherein the first direction preferably is a height direction.

6. Deficiency testing device according to claim 5, when dependent on claim 3 or 4, wherein the central support comprises one or more gas outlets that are configured to provide gas for inflating the outer shell.

7. Deficiency testing device according to claim 6, wherein the central support is a double-walled tubular support, wherein the one or more gas outlets are positioned in an outer wall and wherein a space between an inner and the outer wall comprises a gas flow channel.

8. Deficiency testing device according to any one of the preceding claims, the device comprising a housing enclosing a housing space in which the mannequin, the at least one X-ray detector and the at least one X-ray source are positioned.

9. Deficiency testing device according to any one of the preceding claims, wherein the housing is provided with transport means, wherein the transport means preferably are wheels.

10. Deficiency testing device according to any one of the preceding claims, wherein the at least one X-ray detector is positioned within the mannequin, and wherein the at least one X-ray source is positioned outside the mannequin.

11. Deficiency testing device according to any one of the preceding claims, wherein the mannequin is rotatable around a mannequin axis that extends in a first direction, wherein the first direction preferably is a height direction.

12. Deficiency testing device according to any one of the preceding claims, wherein the at least one X-ray detector or the at least one X-ray source is provided at a stationary position, and wherein the stationary position preferably is a position on a mannequin axis of the mannequin.

13. Deficiency testing device according to claim 11, when dependent on claim 2, wherein the outer shell and the central support are connected to each other and rotatable around the mannequin axis together.

14. Deficiency testing device according to any one of the preceding claims, wherein the at least one X-ray source and/or the at least one X-ray detector are moveable in a first direction, wherein the first direction preferably is a height direction.

15. Deficiency testing device according to any one or more of the claims 1-8, wherein the mannequin comprises a mannequin axis extending in a height direction, wherein the at least one X-ray detector is positioned at a stationary position on the mannequin axis within the mannequin, wherein the mannequin is rotatable around the mannequin axis, and wherein the X-ray source is facing towards the mannequin axis and the at least one X-ray detector and is movable along the height direction.

16. Deficiency testing device according to any one of the preceding claims, comprising a control unit that is configured for, during use of the deficiency testing device, controlling the deficiency testing device, wherein the controlling preferably includes controlling a scanning operation of the deficiency testing device.

17. Deficiency testing device according to claim 16, wherein the control unit further is configured for receiving and processing detection data from the at least one X-ray detector for detecting deficiencies in a garment to be tested.

18. Deficiency testing device according to claim 17, wherein the processing comprises one or more of:
combining the detection data from each scanning step together to obtain a screening image of the garment to be tested;
identifying the presence, and preferably the position of, deficiencies in the garment,
evaluating the detection data to identify deficiencies in the garment;
calculating the percentage and/or the absolute size of deficiencies in the garment relative to its surface;
comparing the percentage and/or the absolute size of deficiencies to a deficiency threshold; and
rejecting the garment if the percentage and/or the absolute size of deficiencies exceeds the deficiency threshold.

19. System for deficiency testing of X-ray protective garments, the system comprising:
at least one deficiency testing device for deficiency testing of X-ray protective garments according to any one of the preceding claims; and
a computing device with a processor; and
a memory for storing at least a part of the detection data.

20. System for deficiency testing according to claim 19, comprising at least one garment to be tested, wherein the garment to be tested comprises an ID-element, such as an ID-tag or bar code.

21. Method for deficiency testing of X-ray protective garments, the method comprising:
providing a deficiency testing device according to any one of the claims 1-16;
providing a garment to be tested to the device; and
operating the device by deficiency testing the garment using X-ray.

22. Method according to claim 21, wherein the step of providing the garment to be tested to the device comprises one or more of the steps of:
opening a door of the device;
positioning garment to be tested in the device;
identifying garment by identifying the ID-element attached thereto;
checking, by an operator, free rotation of the at least one X-ray source, the at least one detector and/or the mannequin relative to each other; and/or
closing the door.

23. Method according to claim 22, wherein the step of positioning garment to be tested on the device comprises one or more of the steps of:
inflating and/or stretching the mannequin;
checking the mannequin, preferably checking the inflated and/or stretched mannequin, to determine whether the garment is positioned substantially straight on the mannequin.

24. Method according to any one or more of claims 21-23, wherein the step of operating the device comprises the steps of:
performing a scanning operation; and
processing the scanning data; and
rejecting the garment if a percentage and/or the absolute size of deficiencies exceeds a deficiency threshold.

25. Method according to claim 24, wherein the step of performing a scanning operation comprises one or more of the steps of:
positioning the device in a first scanning position in which the X-ray source and the garment to be tested are positioned relative to each other at a first height;
X-ray scanning the garments to be tested over a 360° arc in the first scanning position;
positioning the device in a subsequent scanning position in which the X-ray source and the garment to be tested are positioned relative to each other at a second height;
X-ray scanning the garments to be tested over a 360° arc in the subsequent scanning position;
repeating the abovementioned positioning and scanning steps to scan the garment to be tested over its entire height.

26. Method according to claim 24 or 25, wherein the step of processing the scanning data comprises one or more of the steps of:
sending the scanning data from the detector to a control or processing unit;
storing the scanning data in a memory;
stitching the result from each scanning step together to obtain screening image of the garment;
evaluating the screening image using software to identify deficiencies in the garment;
calculating the percentage and/or the absolute size of deficiencies in the garment relative to its surface; and
comparing the percentage and/or the absolute size of deficiencies to a deficiency threshold.

27. Method according to any one or more of claims 21-26, when dependent on claim 24, wherein the steps of performing the scanning operation and processing the scanning data are performed substantially simultaneously.
